(19) United States
(12) Patent Application Publication
(10) Pub. No.: US 2010/0332343 A1
(43) Pub. Date: Dec. 30, 2010

(54) METHOD FOR DISPLAYING MULTIMEDIA CONTENT WITH VARIABLE INTERFERENCE BASED ON RECEIVER/DECODER LOCAL LEGISLATION

(75) Inventor: Stephane Onno, Saint Gregoire (FR)

Correspondence Address: Robert D. Shedd, Patent Operations;THOMSON Licensing LLC, P.O. Box 5312, Princeton, NJ, 08543-5312, US

(73) Assignee: THOMSON LICENSING

(21) Appl. No.: 12/735,908

(22) PCT Filed: Feb. 27, 2009
(86) PCT No.: PCT/FR2009/050314

§ 371 Date: Aug. 24, 2010

(30) Foreign Application Priority Data
Feb. 29, 2008 (FR) 0851352

(51) Int. Cl. H04N 7/167; G06Q 30/00

(52) U.S. Cl. 705/26.1; 380/200

(57) ABSTRACT

A multimedia content receiver/decoder that receives data representing the multimedia content as well as disturbance data associated with the content is disclosed. It processes the data representing the content based on the associated disturbance data locally stored in the receiver/decoder then it transmits to the display means the multimedia content for displaying with a disturbance defined by the disturbance data according to a disturbance level depending on local disturbance rights.

### TECHNICAL DOMAIN OF THE INVENTION

The invention relates to the transmission of multimedia content to receiver/decoders connected to a communication network, via diffusion (or by broadcasting or by point-to-multipoint—such as for example television via cable or via satellite) or via broadband—such as for example television on IP.

It is understood here by “receiver/decoder” any type of equipment comprising, on one hand, communication means enabling at least to receive from a communication network (wired or wireless) blocks of content data, and on the other hand, decoding means responsible for processing blocks of content data received so that the content that they define can be displayed via display means of any type, for example a screen, a video projector or a retro-projector. Consequently, it may for example concern a set-top box type device or a digital decoder being possibly part of a television set, a fixed or portable computer, a fixed or mobile telephone, a communicating Personal Digital Assistant (PDA), or a mobile terminal implanted in a transport vehicle and possibly of TNT/DVB-H type.

Moreover, it is understood here by “multimedia content” any type of set of data defining at least image sequences, possibly accompanied by sound, such as for example videos, publicity films or television programmes. A “multimedia content” can also be simply sound or text data.

Hereafter in the description, there is reference made to the “viewing” or display of a multimedia content but it is evident that it involves more generally a content display (visual display, sound, via text display or mixed).

### PRIOR ART

Persons skilled in the art know that a multimedia content viewing mode has existed for a while called “pay per view”. This viewing mode is based on access to multimedia content, generally encrypted, conditioned by access rights defined according to a payment (possibly in the form of a subscription). The client that benefits from access rights receives on his receiver/decoder multimedia contents that he has requested or that are part of his subscription (for example in the case of paid for television programmes), encrypted via keys. He receives in addition access rights control data (contained usually in messages noted as ECM—for “Entitlement Control Messages”—or in “Licences” used in DRM (Digital Rights Management) systems) enabling the multimedia content encryption keys to be recovered. The client generally has a smartcard that he must insert in his receiver/decoder and that stores the access rights to the contents of the client. Secured data, also stored in the card, are used by the receiver/decoder to recover the encryption keys using access rights control data and to then decrypt some at least of the multimedia content received, thus enabling their display using the associated display means.

Such a broadcast system of multimedia content is notably described in the document US 2004/068541 A1.

It is elsewhere known in the document U.S. Pat. No. 6,937,730 B1 a system in which the contents can be masked, in particular shocking or sensitive contents, before being presented to users. Depending on whether the content transmission channel is reliable or not and depending on whether the receiver of the user is reliable or not, the content masking operation is carried out upstream of the receiver in the chain of transmission or by the receiver itself. The presence or absence of a mask on the content presented to the user depends on the identity of the user and whether he is authorized or not to accede to this content.

### SUMMARY OF THE INVENTION

A disadvantage of the “pay per view” viewing mode evoked above resides in the fact that it is of all or nothing type. More specifically, either the user has access rights to the contents and can thus view the decrypted multimedia contents, or the user does not have access rights and thus he can only view encrypted multimedia contents or a fixed image generally monochrome with a possible message proposing for example to buy the access rights. In other words, persons who do not possess access rights to multimedia contents received cannot know if these latter may be of interest to them.

Moreover, the system described in the document U.S. Pat. No. 6,937,730 B1 has a similar disadvantage, that is to say it also is of all or nothing type. Either the user is authenticated as an authorized user to accede to the content, or he is not and can in no case view this content.

The purpose of the invention is thus to overcome these disadvantages.

For this purpose, the invention proposes first of all a method for displaying multimedia content comprising the steps consisting in: receiving in a receiver/decoder (RD) data representing the multimedia content as well as disturbance data associated with the content, processing the data representing the content according to associated disturbance data and according to disturbance rights stored locally in the receiver/decoder, and displaying the multimedia content with a disturbance defined by the disturbance data according to a disturbance level depending on the local disturbance rights.

The method according to the invention comprises the preliminary steps for: receiving via the receiver/decoder (RD) messages for management of disturbance rights and storage and/or the update of local disturbance rights in the receiver/decoder according to information contained in the disturbance rights management messages.

According to a first embodiment, the method according to the invention can in addition comprise steps of receiving of a user command to reduce the level of disturbance in the display of the multimedia content, updating of local disturbance rights by decrementing of a number of tokens pre-stored in the receiver/decoder, the number of tokens being determined via the user command, and modifying the display of multimedia content according to a new level of disturbance depending on updated local disturbance rights.

According to a second embodiment, the method according to the invention can in addition comprise steps of receiving of a user command to reduce the level of disturbance in the display of multimedia content, transmitting of a request to update the local disturbance rights via purchasing of tokens from a remote server comprising a management module (MGN), receiving via the receiver/decoder (RD) a management message for disturbance rights containing an update of local disturbance rights when the purchase of a token has been carried out via the remote server, updating of disturbance rights in the receiver/decoder according to information contained in the management message of disturbance rights received, and modifying of the display of multimedia content according to a new level of disturbance depending on the local disturbance rights update.

According to a preferential characteristic of the invention, disturbance integrity data are received in the receiver/decoder with the data representing the multimedia content and disturbance data associated with the content, the method also comprises steps consisting in: verifying the integrity of disturbance data received using disturbance integrity data prior to the displaying of multimedia content, and
in the case where the step of verification of the integrity reveals that the disturbance data are not correct, displaying the multimedia content with a predefined maximum disturbance level,
in the case where the step of verification of the integrity reveals that the disturbance data are correct, displaying the multimedia content with a disturbance level depending on the local disturbance rights of the receiver/decoder (RD).

According to another particular characteristic of the method of the invention, during the step of reception of data representing multimedia content via the receiver/decoder (RD), it is received in encrypted form, this step comprising in addition the reception via the receiver/decoder of access rights control data. Prior to the step of processing of data representing the multimedia content in the receiver/decoder, the method comprises also a step consisting in decrypting the data representing the multimedia content using encryption keys obtained from access rights control data if the receiver/decoder has a right to access to the content.

According to an advantageous characteristic of the invention, the disturbance integrity data and the access rights control data are received by the decoder/receiver in protected messages, preferably via encryption.

The method of the invention can have other particular characteristics that can be taken individually or in combination, and particularly:
the disturbance data may contain a disturbance content intended to mask at least in part the multimedia content or alteration data of the multimedia content intended to modify the display of the multimedia content during its display.
the disturbance data can contain several different publicity contents associated with different user profiles, and the method can also comprise a step consisting in determining in the receiver/decoder the publicity content to be inserted, in the form of disturbance during the displaying of the multimedia content.
prior to the step of displaying the multimedia content with disturbance defined by the disturbance data according to a level of disturbance depending on local disturbance rights, the method can comprise a step of displaying the multimedia content without any disturbance during a predefined period.

The invention also proposes a multimedia content receiver/decoder comprising: communication means equipped to receive from a communication network data representing the multimedia content as well as decoding means equipped to process said data representing the content according to associated disturbance data and according to disturbance rights stored locally in the receiver/decoder and to provide to the viewing means the multimedia content with a disturbance defined by the disturbance data according to a disturbance level depending on the local disturbance rights.

The invention also relates to a provider device of multimedia content intended to be transmitted to receiver/decoders connected to a communication network, comprising means for generation of disturbance data associated with the content intended to be used by said receiver/decoders to process the data representing the content according to the disturbance rights stored locally in the receiver/decoders to display the multimedia content with disturbance defined by the disturbance data according to a disturbance level depending on the local disturbance rights.

### BRIEF DESCRIPTION OF THE DRAWINGS

Other characteristics and advantages of the, invention will appear upon examination of the detailed description hereafter, and the annexed drawings, wherein:

FIG. 1 shows in a diagrammatic and functional manner an example of communication equipment comprising an embodiment of a multimedia content provision device according to the invention, and an embodiment of a receiver/decoder according to the invention, both connected to a communication network,

FIG. 2 diagrammatically shows a first example of an image displayed with a disturbance shown in the form of a greyed rectangle,

FIG. 3 diagrammatically shows a second example of an image displayed with a disturbance shown in the form of a publicity banner, and

FIG. 4 diagrammatically shows an example of an image displayed with two disturbances shown respectively in the form of a greyed rectangle and in the form of a publicity banner.

### DETAILED DESCRIPTION

The purpose of the invention is to enable the viewing via receptor/decoders, connected to a communication network, of multimedia contents with a variable disturbance according to local rights.

Hereafter, it is considered, as a non-restrictive example, that the communication network is a satellite network. But, the invention relates to any type of communication network able to transmit to receiver/decoders that are connected to it (or that can be reached via its intermediary), in point-to-multipoint (or “broadcast) mode or point-to point (or “unicast”) mode, and on a broadcast channel, blocks of data (such as for example IP packets) defining multimedia contents. Thus it also relates to the high bitrate wired networks, such as for example cable networks or telephone networks of xDSL type, local wired networks, such as for example those of LAN (Local Area Network) type, and wireless (or radio) communication networks, such as for example mobile or cellular telephone networks (GSM/GPRS, EDGE, UMTS, CDMA2000 and their extensions and equivalents), and local wireless networks (WLAN (“Wireless Local Area Network” standards—IEEE 802.11, Wi-Fi, Wi-Fi MIMO, ETSI HiperLAN/2), Bluetooth (IEEE 802.15), WiMAX (IEEE 802.16, ETSI HiperMAN) and Zigbee).

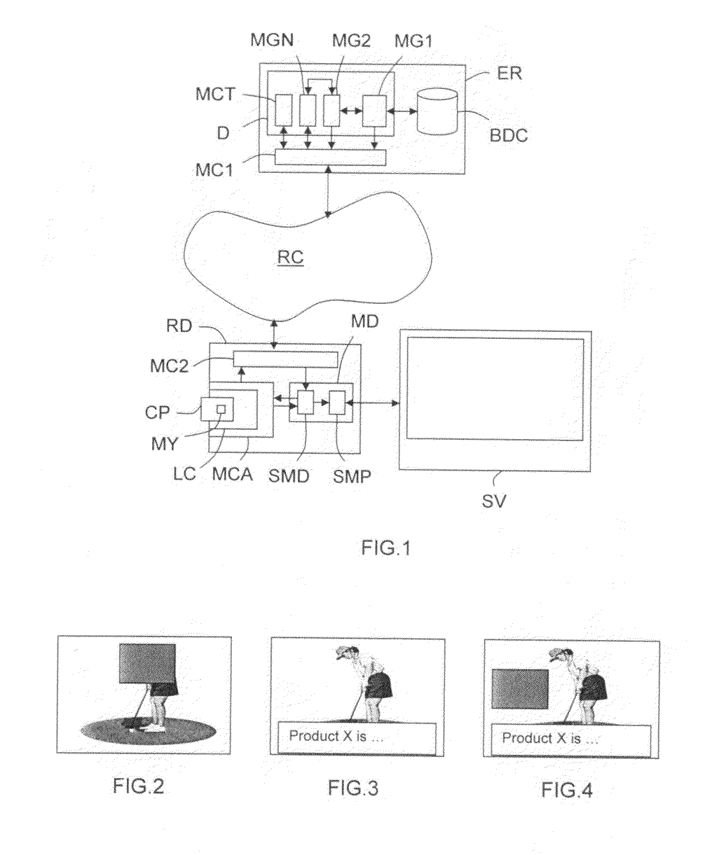

As diagrammatically shown in FIG. 1, the implementation of the invention requires a communication network RC, a multimedia content provision device ER and receiver/decoders RD coupled with content viewing means SV.

The multimedia content provision device ER is for example a content server delivering multimedia contents (image sequences generally accompanied by a sound track), such as television programmes (publicity films or videos), in the form of blocks of content data, preferably encrypted. For example, this content server ER is an IP server delivering blocks of content data encrypted in the form of

IP (Internet Protocol) packets. This content server ER comprises at least one communication module MC1 connected to the communication network RC, a multimedia content provision device D, according to the invention, and a content database BDC in which are stored the multimedia contents to be transmitted to the receiver/decoders RD. It is noted that in the variants, the device D can itself comprise the contents database BDC and/or the communication means MC1.

The device D according to the invention comprises at least a first encryption module MG1 and a second disturbance data generation module MG2.

The first encryption module MG1 is coupled with the contents database BDC in order to encrypt the multimedia contents data blocks that are stored and to deliver these encrypted blocks on an output coupled to the communication module MC1 with a view to their transmission (broadcast) to the receiver/decoders RD. The encryption is made by means of keys that are themselves transmitted in the content access rights control data (such as ECM messages or Licences) that the encryption module MG1 delivers at its output.

The second disturbance data generation module MG2 is responsible for delivering at an output at least the disturbance data that are representative of content disturbance(s) and that will be locally used by the receiver/decoders RD to process the blocks of data transmitted (broadcast) for the purpose of the viewing of contents that they represent in an interfered form according to their respective local disturbance rights.

It is understood here by “disturbance” anything that can be added in “overlay” mode to a multimedia content to be viewed and any alteration or degradation of a multimedia content. Disturbance thus does not necessarily imply a degradation of the multimedia content viewed.

Consequently, the disturbance data designating here everything that may constitute a disturbance content (such as for example a publicity to be inserted in a multimedia content) or a definition of a disturbance to be applied to a multimedia content (such as for example the addition of a filled rectangle or a frame or the suppression from a zone of a multimedia content). The disturbance data are either data that have been added to the multimedia content to mask some parts during the display (“overlay” data), or multimedia content modification data that will modify the appearance of this content during its display.

Examples of disturbances are shown by FIGS. 2 to 4.

The example shown in FIG. 2 corresponds to a disturbance of each image of a displayed content (after a certain selected delay) that consists in an insertion of a greyed rectangle (or the replacement of some pixels by grey pixels) in a selected zone (for which the emplacement possibly varies from one image to another). The example shown in FIG. 3 corresponds to a disturbance of each image of a displayed content (after a certain selected delay) that consists in an insertion of a banner containing a publicity message (or the replacement of some pixels by grey pixels) in a selected zone (for which the emplacement possibly varies from one image to another).

The disturbance data can also correspond to a combination of at least two different types of disturbance. This is notably the case in the example shown in FIG. 4 wherein each image of a displayed content (after a certain selected delay) is subject to both an insertion of a greyed rectangle (or the replacement of some pixels by grey pixels) in a selected zone (for which the emplacement possibly varies from one image to another) and an insertion of a banner containing a selected publicity message (for which the emplacement possibly varies from one image to another).

Numerous other examples of disturbance and disturbance combinations may be envisaged, with a progressive or constant character.

It is important to note that the disturbance(s) of content, that are delivered in the form of disturbance data, are applied to multimedia contents according to disturbance rights that must not be confused with multimedia contents access rights. Theses disturbance rights define the level of disturbance that is applied locally. For example, the level of disturbance can be a level of transparency (from 0%—completely transparent—to 100%—completely opaque) of disturbance data displayed as overlay on the original multimedia content. The level of disturbance can also be an audio volume when the disturbance data are audio data.

Any type of content disturbance can be envisaged, and notably:
the overlay on images of a multimedia content of a banner containing another publicity content, for example from the provider of the multimedia content to be viewed,
the overlay on the images of a multimedia content of a visual or audio copyright message,
the overlay on images of a multimedia content of an information message, such as for example an invitation to buy the programme defined by the content,
the overlay on images of a multimedia content of at least one identifier representative of the user concerned, such as for example his name and/or his communication identifier,
the addition of sounds with no relation to the multimedia content,
the degradation or suppression of the sound accompanying the image sequences,
the replacement of a multimedia content to be viewed by at least one fixed monochrome image (or “blank image”), for example a black or white screen background,
the degradation of images of a multimedia content to be viewed defined by at least one selected type (progressive degradation between an optimal quality level and a degraded level, degradation constant defined by a selected disturbance rights, degradation of a part of the image only, rotation of image zones, suppression of some parts of the image, etc.).

It is important to note that several disturbance types can be applied conjointly.

Moreover, the disturbance data can possibly define several different publicity contents associated with different user profiles. In this case, the publicity content that is inserted (as overlay) on the multimedia content to be viewed is selected locally by a decoding module MD of the receiver/decoder according to the user profile (that it stores in a local memory).

The content disturbances can be possibly according to contents that they compliment, the second disturbance data generation module MG2 is preferably coupled with the first encryption module MG1 in order to be able to synchronise their operations, as shown in FIG. 1.

The blocks of encrypted (coded) content data, the complementary disturbance data (that contain for example the content—text, image, etc.—of the disturbance as well as its positioning in the screen), and the control data to content access rights (containing the content encryption keys), are transmitted by the communication module MC1 to the network RC so that it can transmit (broadcast) it in turn to the receiver/decoders RD concerned.

Preferably, when the data are transmitted by “broadcast” type diffusion, the blocks of content data are transmitted on the broadcast channel in a transport stream, with the disturbance data. For example, if the coding standard ISO/IEC 13818-1 is used, the blocks of data containing the video are transmitted in packets having a first specific identifier PID (Packet Identifier), the blocks of data containing the audio are transmitted in packets having a second PID and the disturbance data are transmitted in packets of data having a third PID. Moreover, the access rights control data are transmitted on the broadcast channel in complementary messages for example of ECM (Entitlement Control Message) is type that are themselves transmitted in packets having their own specific PID. These ECM type messages are preferably protected by coding and only the receiver/decoders that are authorized contain the keys enabling these ECM to be decoded. When the data are transmitted in “broadband” diffusion mode, the blocks of content data are transmitted in a “broadcast” or “multicast” stream with the disturbance data and the access rights control data.

It is also noted that a mechanism for verification of the integrity of disturbance data that are transmitted with the content can be provided. To do this, the device D can add to the disturbance data disturbance integrity data that are transmitted preferentially in the protected messages (of ECM type) already containing access rights control data. This integrity data is generated according to disturbance data that can be applied to the multimedia content transmitted, for example by application of a hash function to the disturbance data.

This integrity data is used then at each receiver/decoder to verify that the disturbance data have not been modified (for example to render the disturbance minimal) illegally.

Later this document will discuss the additional modules that the device D could possibly comprise according to the invention.

Each receiver/decoder RD comprises at least one communication module MC2 and a decoding module (or unit) MD.

The receiver/decoder RD is for example a Set-Top Box or digital decoder type item of communication equipment. It can for example be connected to, or be part of, a television set SV (as in the example shown in FIG. 1) a fixed or portable computer, a mobile or fixed telephone, a communicating digital personal assistant (or PDA), or mobile terminal implanted in a transport vehicle and possibly of TNT/DVB-H type.

The communication module MC2 is coupled to the communication network RC. It is at least responsible for receiving this latter, on a broadcast channel, on one hand, blocks of content data (preferably coded) and complementary disturbance data and on the other hand disturbance integrity data as well as access rights control data transmitted in protected messages, everything being from the content server ER.

The decoding module MD is coupled to the communication module MC2 in order to receive the blocks of content data, the disturbance data, the disturbance integrity data and the access rights control data that it receives from the network RC.

This decoding module MD is responsible for processing the blocks of content data according to associated disturbance data received in complement to the content and according to the disturbance rights stored locally in the receiver/decoder so that the content to be viewed integrates each disturbance according to the local disturbance rights.

As shown in FIG. 1, the decoding module MD comprises for example a decoding sub-module SMD, responsible for decoding blocks of content data when they are received in a coded form to deliver a content to be viewed. The module MD also comprises a disturbance(s) integration sub-module SMP, coupled at the output of the decoding sub-module SMD and responsible for adding disturbance to the content to be viewed according to the local disturbance rights (that is to say specific to the receiver/decoder RD considered).

This local disturbance rights is received previously in the receiver/decoder RD, for example in disturbance rights management messages (similar to messages noted as EMM—for “Entitlement Management Message”—in conditional access systems or “Licences” used in the DRM systems). These disturbance rights management messages are addressed specifically to the receiver/decoder and are thus intended for a single receiver/decoder (or a determined group of receiver/decoders). These disturbance rights management messages are transmitted in a de-correlated manner with respect to the content itself. Typically, when the content is transmitted by “broadcast” type diffusion, the disturbance rights management messages are transmitted in carrousel, that is to say repeatedly, in the stream. When the content is transmitted in “broadband” diffusion mode the disturbance rights management messages are transmitted in a “unicast” stream between the server ER and the receiver/decoder RD. New disturbance rights management messages are addressed to the receiver/decoder when the user modifies his subscription or when he buys additional rights to reduce the disturbances for example.

The sub-modules SMD and SMP are, in the embodiment, connected to an access control module MCA. This access control module MCA recovers the content coding keys using the access rights control data and the secured data stored in a secured local memory.

This local memory is for example contained in a smartcard CP. In this case, and as shown in FIG. 1, the access control module MCA comprises a card reader LC able to receive the smartcard CP and read the information stored in its memories.

Once the content coding keys are determined, the access control module MCA transmits them to the sub-module SMD. This latter is then able to decode the blocks of encoded content data received.

The result is fractions of content that are transmitted to the disturbance integration sub-module SMP. This latter is for example deactivated for a selected duration that follows the commencement of the local reception of a multimedia content in order to enable the viewing without any disturbance over a selected duration. In this case, it transmits directly to the viewing means SV the fractions of content decoded by the decoding sub-module SMD so that they commence to be displayed without any disturbance.

In a variant, the disturbance data received can impose that the disturbances integration sub-module SMP inserts in each image (or group of images) of the multimedia content to be viewed an information message proposing access to this latter according to disturbance levels that depend on a number of tokens purchased. In fact, the user can purchase additional rights to reduce the disturbances in the form of tokens for example. The purchase of a determined number of tokens enables the local disturbance rights to be modified to reduce the level of disturbance of the displayed content. In this case, the user begins by viewing the multimedia content with the information message, and either he decides to purchase tokens and in this case he will view the rest of the multimedia content with a disturbance level (or rights) according to the number of tokens bought, or he refuses to purchase tokens. In this latter case, he will view the rest of the multimedia content in a partially or totally interfered form according to the disturbance data received with the multimedia content and according to the local disturbance rights stored in the receiver/decoder.

If the disturbance data do not immediately impose the insertion of an information message, it is the access control module MCA that can order the display via the viewing means SV of a message proposing to the user of the receiver/decoder RD to purchase a number of tokens enabling the local disturbance rights to be reduced.

It is understood here by “heightened disturbance rights” a rights corresponding to a heightened (or high level of) disturbance and by “low disturbance rights” a low level of disturbance.

As a non-restrictive example, the purchase of a token enables a viewing according to a heightened rights level (but not maximum, such as for example an average degradation of the image and or sound quality combined with the insertion of a publicity banner), the purchase of three tokens may enable a viewing according to a mean disturbance rights (such as for example a low degradation of the image and/or sound quality combined with the insertion of a publicity banner), the purchase of five tokens may enable a viewing according to a low disturbance rights (such as for example a low degradation of the image and/or sound quality) and the purchase of ten tokens may enable a viewing according to a null disturbance rights (corresponding to optimal image and sound quality—without disturbance).

The number of tokens purchased by the user (here comprised between zero (0) and ten (10)) corresponds to a sum of money that must be debited either from a bank account, or from a local account.

For example, the access control module MCA is equipped to cut the number of tokens that a user wants to buy from a number of pre-purchased tokens that are stored in a local memory MY. This latter is for example contained in the smartcard CP. In this case, the card reader LC is also able to read the number of pre-purchased tokens that are found stored in the memory MY and replace it with a new number that is equal to the result of the cutting of the number of tokens that the user wants to purchase from this pre-purchased number of tokens.

It will be noted that this method of updating the local disturbance rights locally at the level of the receiver/decoder (by cutting the number of tokens stored in a secured local memory), is an alternative to the method of updating local disturbance rights described previously, by the transmission of disturbance rights management messages (of “EMM” type).

If the number of tokens stored is not sufficiently high, or if the access control module MCA is not designed to carry out the debiting (or cutting) operation, then it can establish a connection with the device D, implanted in the content server ER, on a return channel of a communication network (that is not necessarily the same as that RC used for the broadcast channel). It can then order a communication channel MC2 of its receiver/decoder RD to transmit to the content server ER the request to purchase tokens performed by the user.

In this case, the device D comprises a management module MGN coupled to the communication module MC1 and responsible for organising the debiting of an account (bank account or account of pre-purchased tokens) belonging to the user that carried out the purchase request. If this is possible, the management module MGN debits the account by an amount corresponding to the purchase of the number of tokens selected by the user or by the number of tokens selected. Then, the management module MGN delivers to the communication module MC1 a message confirming the purchase of a requested number of tokens (or the rejection of the purchase request) so it can transmit it to the receiver/decoder RD concerned (in unicast mode), preferably on the broadcast channel of the communication network RC (but this can equally be done on the return channel which is generally of bidirectional type). When the communication module MC2 of the receiver/decoder RD concerned receives such a message, it communicates it to the decoding module MD that transfers it to the access control module MCA.

It will be noted that the management module MGN is not necessarily included in the content distribution server D. It can also be part of a server of a financial intermediary, such as a bank.

The device D can also comprise a control module MCT responsible for determining the access rights data to the contents diffused for a receiver/decoder

RD. In this case, it determines in a client database what content types the user of the receiver/decoder RD is authorized to view according to his subscription or specific purchases of “pay per view” contents. This operating mode is particularly known in paid for television applications or CA TV (Conditional Access TV).

This access rights data specific to each receiver/decoder is generally transmitted at the start of each month with the associated disturbance rights to the receiver/decoder. The data are transmitted on the broadcast channel and in a stream by means of complementary messages address specifically to a receiver/decoder, for example of EMM (Entitled Management Message) type. When the communication module MC2 of the receiver/decoder RD receives a complementary message of this type, it communicates the access rights data and the disturbance rights data to the decoding module MD to then store them in a secured manner in the memory of the card CP.

It will be noted that the access rights to the content and the local disturbance rights are stored in a secured memory such as the memory of a. smartcard or a secured USB key. They can also be contained in a licence file DRM for example that is itself protected by coding using keys protected by certificates. The modules MCA, SMD and SMP shown in FIG. 1 that apply to or process the access rights to content of the disturbance rights must also be secured: it is thus either applications that are run by a secured processor (smartcard for example), or applications secured by “secure coding”.

When the receiver/decoder RD receives in its decoding module MD the blocks of content data as well as the disturbance data, the disturbance integrity data and the access rights control data, it carries out two verifications (typically in the MCA module or in the SMD module). A first verification consists in comparing the access rights data stored in the secured memory (for example that of the card CP) of the receiver/decoder with the access rights control data transmitted with the content to ensure that the user of the decoder is indeed authorized to receive this content and also to recover the coding keys of the content as seen previously. A second verification is carried out to verify the integrity of disturbance data received using the disturbance integrity data. For example, if the integrity data is generated (by the server ER) applying a hash function to the disturbance data, the verification in the receiver/decoder consists in applying the same hash function to the disturbance data received and comparing the result of this calculation to the disturbance integrity data received.

If this second verification reveals that the disturbance data are not correct (that is to say they were modified with respect to their initial content), then a maximum disturbance level will be applied by the receiver/decoder in the displaying of the content, and this whatever the local disturbance rights.

If however, the second verification reveals that the disturbance data are correct, then the sub-module SMP will apply the disturbance defined by the disturbance data according to a disturbance level dependant of the local disturbance rights. Moreover, the user of the receiver/decoder is invited to reduce the level of disturbance by acquiring new disturbance rights (in fact, rights (to reduce” the disturbance) either locally, by cutting of tokens from his smartcard for example, or by an exchange with the server ER.

It will be noted that to avoid that a user passes frequently from one programme that interests him to another, and thus deactivates each time the disturbance integration mechanism is a way to noticeably continuously benefit the programme that interests him, it can be considered that the disturbance integration sub-module SMP is configured to automatically apply to the content the highest disturbance rights (high disturbance—for example a fixed monochrome image possibly without accompanying sound) after a number of changes selected (for example two or three counted by a dedicated counter).

It will also be noted that in the absence of a determination of local disturbance rights, the disturbance integration sub-module SMP is preferentially configured so as to automatically apply by default to the decoded content to be viewed the highest disturbance rights (high disturbance—for example a fixed monochrome image possibly without accompanying sound).

It is also noted that the decoding module MD, and for example its disturbance integration sub-module SMP, can be equipped so as to force a local contents recording device, that is coupled to one of the outputs of the receiver/decoder RD or the viewing means SV, to record the contents decoded with the disturbances corresponding to either local disturbance of the receiver/decoder, or to the highest disturbance rights—for example a fixed monochrome image possibly without accompanying sound). This latter hypothesis is intended to prohibit the reproduction of content without authorization. In a variant, it can be considered that the disturbance rights, that correspond to the tokens purchased by the user, also defines a content reproduction right. For example, it can be considered that at least one user identifier is recorded at the same time as the decoded content, in order to be able to determine who is at the origin of the content reproduction.

The decoding module MD (SMD and SMP) is preferentially realized in the form of software modules. But, it can be considered that it can be realized in the form of electronic circuits (hardware) or of a combination of software modules and hardware.

Likewise, the device D is preferentially realized in the form of application modules (software). But, it can be considered that it can be realized in the form of electronic circuits (hardware) or of a combination of software modules and hardware.

The invention is not restricted to embodiments of the method for viewing multimedia contents, the receiver/decoder and the multimedia contents provision device described above, provided only as a non-restrictive example, but includes all the variants that can be envisaged by those skilled in the art in the framework of the following claims.

1. A method for displaying multimedia content comprising the following steps for:
receiving in a receiver/decoder data representing the multimedia content as well as disturbance data associated with the content,
processing the data representing the content according to associated disturbance data and according to disturbance rights stored locally in the receiver/decoder, and
displaying the multimedia content with a disturbance defined by the disturbance data according to a level of disturbance among a plurality of disturbance level, the disturbance level depending on local disturbance rights.

2. The method according to claim 1, wherein it comprises the preliminary steps of
receiving by the receiver/decoder of disturbance rights management messages and of
storing and/or updating of local disturbance rights in the receiver/decoder according to information contained in the disturbance rights management messages.

3. The method according to claim 1, wherein it also comprises steps of:
receiving of a user command to reduce the disturbance level in the displaying of the multimedia content,
updating of local disturbance rights by decrementing a number of tokens pre-stored in the receiver/decoder, the number of tokens being determined by the command of the user, and
modifying the display of the multimedia content according to a new level of disturbance depending on the updated local disturbance rights.

4. The method according to claim 2 wherein it also comprises steps of:
receiving of a user command to reduce the level of disturbance in the displaying of the multimedia content,
transmitting of a request for updating the local disturbance rights through the purchasing of tokens from a remote server comprising a management module,
receiving via the receiver/decoder of a disturbance rights management message containing a local disturbance rights update upon the purchase of tokens that can be carried out via the remote server,
updating of local disturbance rights in the receiver/decoder according to information contained in the disturbance rights management messages, and
modifying the display of the multimedia content according to a new level of disturbance depending on the updated local disturbance rights.

5. The method according to claim 1 wherein disturbance integrity data are received in the receiver/decoder with data representing the multimedia content and disturbance data associated with the content,
and in that the method also comprises steps for:
verifying the integrity of disturbance data received using disturbance integrity data prior to the displaying of multimedia content, and
in the case where the step of verification of the integrity reveals that the disturbance data are not correct, displaying the multimedia content with a predefined maximum disturbance level,
in the case where the step of verification of the integrity reveals that the disturbance data are correct, displaying the multimedia content with the disturbance level depending on the local disturbance rights of the receiver/decoder.

6. The method according to claim 1 wherein during the step of reception of data representing the multimedia content by the receiver/decoder, data is received in encrypted form, said step further comprising the reception via the receiver/decoder of access rights control data and wherein
prior to the step of processing of data representing the multimedia content in the receiver/decoder, the method further comprises a step consisting in decrypting the data representing the multimedia content using the encryption key obtained from access rights control data if the receiver/decoder has a right to access to the content.

7. The method according to claim 6, wherein the disturbance integrity data and the access rights control data are received by the decoder/receiver in protected messages, preferably via encryption.

8. The method according to claim 1 wherein the disturbance data contains a disturbance content intended to mask at least in part the multimedia content or alteration data of the multimedia content intended to modify the display of the multimedia content during its display.

9. The method according to claim 8, wherein the disturbance data can contain several different publicity contents associated with different user profiles, and in that the method further comprises a step consisting in determining in the receiver/decoder the publicity content to be inserted, in the form of disturbance, during the displaying of the multimedia content.

10. The method according to claim 1, wherein, prior to the step of displaying the multimedia content with a disturbance defined by the disturbance data according to a level of disturbance among a plurality of disturbance levels, the disturbance level depending on local disturbance rights, the method comprises a step of displaying the multimedia content without any disturbance during a predefined period.

11. A receiver/decoder of multimedia content comprising:
communication means equipped to receive from a communication network data representing the multimedia content as well as disturbance data associated with the content and
decoding means equipped to process said data representing the content according to associated disturbance data and according to disturbance rights stored locally in the receiver/decoder and to provide to the viewing means the multimedia content with a disturbance defined by the disturbance data according to a level of disturbance among a plurality of disturbance levels, the disturbance level depending on the local disturbance rights.

12. A device for providing multimedia content intended to be transmitted to receiver/decoders connected to a communication network, comprising means for generation of disturbance data associated with the content intended to be used by said receiver/decoders to process the data representing the content according to the disturbance rights stored locally in the receiver/decoders to display the multimedia content with a disturbance defined by the disturbance data according to a disturbance level among a plurality of disturbance levels, the disturbance level depending on the local disturbance rights.
